(19) United States
(12) Patent Application Publication
(10) Pub. No.: US 2019/0370804 A1
(43) Pub. Date: Dec. 5, 2019

(54) METHOD FOR AUTOMATING CHECKOUT PAGE CATEGORIZATION

(71) Applicant: Capital One Services, LLC, McLean, VA (US)

(72) Inventors: Robert Perry, Ashburn, VA (US); Jonathan Bodner, Potomac, MD (US); Daniel Herrington, New York, NY (US); Stephen Schneider, Midlothian, VA (US); James Zarakas, Centreville, VA (US)

(73) Assignee: Capital One Services, LLC, McLean, VA (US)

(21) Appl. No.: 16/000,274

(22) Filed: Jun. 5, 2018

(51) Int. Cl. G06Q 20/40; G06Q 20/38; G06F 17/30

(52) U.S. Cl. CPC G06Q 20/40; G06F 17/30896; G06Q 20/382

(57) ABSTRACT

A system and method of identifying a credit card input field on a webpage is described. A processor may determine if a user's input includes a numerical sequence. The processor may determine if the number of digits in the numerical sequence matches a value that is pre-determined by a financial service provider. The processor may determine if one or more opening digits of the numerical sequence match a sequence that is pre-defined as identifying a financial service provider. The processor may validate the numerical sequence using a pre-determined algorithm. The processor may determine if any labeling texts associated with the input field match pre-determined texts. The processor may generate a file labeling the input field as a credit card input field.

### FIELD

The present disclosure generally relates to online payment technology.

### BACKGROUND

Because consumers' commercial activities (e.g., shopping, travel booking) have been shifting to the Internet, online payment is now a critical component for online transactions. For example, credit cards are among the most popular payment methods because of their ease of use. However, there are increasing security risks associated with card-based transactions. Since payment information is transmitted through the Internet, data may be intercepted or hacked by a third party. Even though end-to-end data encryption is becoming more common, users' card information is still at a risk because of the complexity of the system and the lack of uniformity of security measures across the e-commerce industry. Therefore, there is a need for a system and method of protecting users' credit card information during online transactions.

### SUMMARY

In an aspect of the present disclosure, a computer-implemented method of identifying a credit card number input field on a webpage with a browser extension includes receiving, by an input device, a user's input for an input field on the webpage from a user, wherein the user's input comprises a numerical sequence having a total number of digits and one or more opening digits; receiving, by a processor, the user's input from the input device; determining that the number of digits matches a pre-determined value; determining that the one or more opening digits match a pre-defined sequence; generating a file associated with the webpage, wherein the file labels the input field as a credit card number input field, in response to the number of digits matching the pre-determined value and the one or more opening digits matching the pre-defined sequence; and transmitting the generated file to a server, wherein the server is configured to store the file in a storage device associated with the server.

In some embodiments of the method, the pre-determined value is set by a financial service provider. The pre-determined value may be one of 13, 14, 15, 16, 17, 18, and 19. The pre-defined sequence may include an identification number of a financial service provider. The financial service provider, in some embodiments, is a credit card processor, a debit card processor, or a gift card processor. In various embodiments, the method further includes determining that the numerical sequence is valid under Luhn algorithm; and updating the file labeling the input field as a credit card number input field. The method may also include scanning one or more characters on the webpage; determining that the one or more characters on the webpage match one or more pre-determined texts; and updating the file labeling the input field as a credit card number input field. The one or more pre-determined texts may include “credit card number”, “CVV”, “security code”, “verification code”, “expiration date”, or “EXP”.

In some aspects of the present disclosure, a computer-implemented method of identifying a credit card number input field on a webpage includes receiving, by a server, a user's input for an input field on the webpage from a user device, wherein the user's input comprises a numerical sequence having a total number of digits and one or more opening digits; determining that the number of the digits matches a pre-determined value; determining that the one or more opening digits match a pre-defined sequence; determining that the numerical sequence is valid under Luhn algorithm; generating a file associated with the webpage, wherein the file labels the input field as a credit card number input field; and storing the generated file in a memory.

In various embodiments of the method, the user device includes a computer or a mobile device. the pre-determined value may be defined by a financial service provider. The pre-defined sequence may identify a financial service provider. The pre-defined sequence, in some embodiments, is 34, 37, 4, 51, 52, 53, 54, 55, 6011, 62, 64, or 65.

In one aspect of the present disclosure, a system of identifying a credit card number input field on a webpage includes an input device configured to receive a user's input from a user, wherein the user's input comprises a numerical sequence having a plurality of digits and one or more opening digits; a memory configured to store program instructions; and a processor. The processor may be configured to execute the program instructions causing the processor to receive the user's input from the input device; determine that the number of digits matches a pre-determined value; determine that one or more opening digits match a pre-defined sequence; determine that the numerical sequence is valid under a pre-determined algorithm; generate a file associated with the webpage, wherein the file labels the input field as a credit card number input field, in response to the number of the digits matching the pre-determined value and the one or more opening digits matching the pre-defined sequence and the numerical sequence being valid under the pre-determined algorithm; and transmit the generated file to a server, wherein the server is configured to store the file in a storage device associated with the server.

In some embodiments, the pre-determined value is defined by a financial service provider. The pre-defined sequence may identify a financial service provider. The financial service provider, in various embodiments, is a credit card processor, a debit card processor, or a gift card processor. The pre-determined algorithm may include Luhn algorithm. The program instructions may further cause the processor to scan one or more characters on the webpage; determine that the one or more characters match one or more pre-determined texts; and update the file labeling the input field as a credit card number input field. The one or more pre-determined texts may include “credit card number”, “CVV”, “security code”, “verification code”, “expiration”, or “EXP”.

### BRIEF DESCRIPTION OF THE DRAWINGS

To assist those of skill in the art, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting.

FIG. 1 is an exemplary checkout webpage for an online transaction, according to some embodiments of the present disclosure.

FIG. 2 is a flowchart showing a method of identifying a credit card input field on a webpage, according to some embodiments of the present disclosure.

FIG. 3 is a flowchart showing another method of identifying a credit card input field on a webpage, according to some embodiments of the present disclosure.

FIG. 4 is a block diagram showing various components within a system for online payments, according to some embodiments of the present disclosure.

### DETAILED DESCRIPTION

In order to solve the security issues associated with credit card transactions and to combat fraud, card issuers have implemented various advanced technologies, such as EMV (named after Europay™, MasterCard® and Visa®) standard cards having a microchip for storage of sensitive card information. While EMV enabled cards can be effective in preventing physical card fraud, a user's credit card information remains vulnerable during an online transaction.

Another way to protect credit card information is to completely replace the real card number with another identifiable number during a transaction. For example, instead of real credit card number, Apple Pay® (provided by Apple Inc.) uses a device-specific encrypted Device Account Number on an Apple® device for payment purposes. While this technology enhances the security level around physical in-store payments, there are still obstacles preventing it from becoming a popular option for online transactions.

A better approach of protecting the real credit card number may be browser-based. A user may install a browser extension provided by a card issuer. In some embodiments, the browser extension may include Chrome™ browser extensions, Firefox® add-ons, etc. In some embodiments, the browser extension may be written using web technologies (e.g., JavaScript, HTML, CSS). In some embodiments, the browser extension may communicate with a server. After necessary authentications, the browser extension may automatically substitute the user's credit card number with another identifiable number (e.g., a virtual card) during online payment processes.

A current approach for a browser to recognize an input field relies on an attribute or label designated by a web developer. For example, an input field may be marked as “name”, “address”, “zip code”, or others in the webpage source code by the web developer. The browser may then recognize the input field and automatically fill it with pre-stored user's information. However, this approach merely depends on the pre-defined attribute. If the web developer does not label the input field with the attribute, the browser may not be able to correctly recognize it.

The present disclosure describes a system and method of identifying a credit card input field on a webpage with a browser extension. . In some embodiments, the browser extension may include Chrome™ browser extensions, Firefox® add-ons, etc. In some embodiments, the browser extension may be written using web technologies (e.g., JavaScript, HTML, CSS). In some embodiments, the browser extension may communicate with a server to authenticate the user, to fetch the virtual card information (card number, CVV, expiration, etc.), to get updated detection and population rules, and to send metrics to the server.

In some embodiments, the system may be configured to monitor every page that a user visits, comparing the page against a set of rules that may be stored within the browser extension. If the page is not one that has been recognized as a payment page, the system may be configured to determine if the user types in a credit card number or if the page adds or shows fields that match one of a detection rule. For example, the system may identify a credit card input by checking if a user's input includes a numerical sequence having a plurality of digits and if the digits match a pre-determined credit card number pattern. In some embodiments, the system may scan text around the input field and compare the text to pre-determined text in order to determine a credit card input. In some embodiments, the system can generate a file associated with the webpage, wherein the file labels the input field as a credit card input field. In some embodiments, the system may transmit the generated file to a server which stores the file in a storage device. The stored file can then be used later for identification purposes.

In some embodiments, the system and method disclosed herein may also be used to identify an input field for a debit card, a gift card, or other payment card.

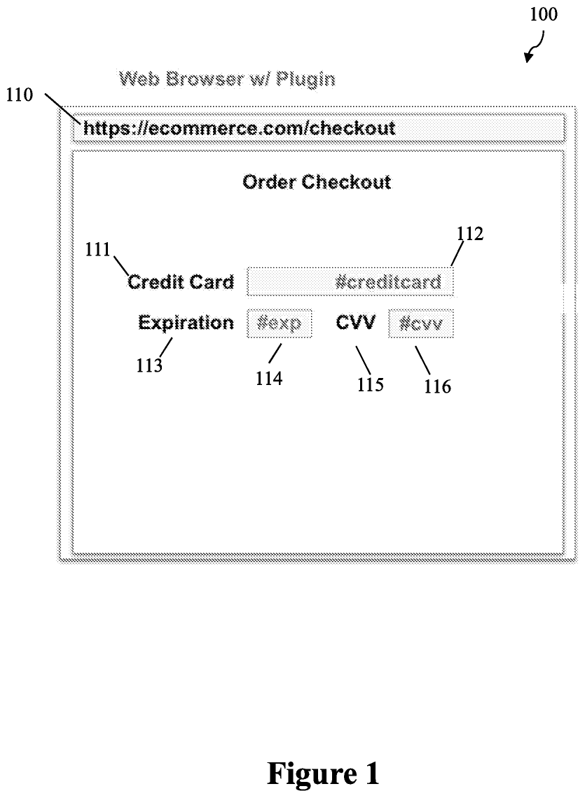

FIG.1 is an exemplary checkout webpage 100 for an online transaction, according to some embodiments of the present disclosure. In some embodiments, webpage 100 may be designed to include one or more input fields for the user to enter payment information. Webpage 100 may also be designed to include text around the input fields to label the input fields and provide instructions to the user. For example, on exemplary checkout webpage 100 associated with the web link 110, there may be input fields 112 (credit card number), 114 (expiration date), and 116 (card verification value or CVV). The webpage 100 may also include labeling texts corresponding to the input fields, such as 111 “credit card”, 113 “expiration”, and 115 “CVV”.

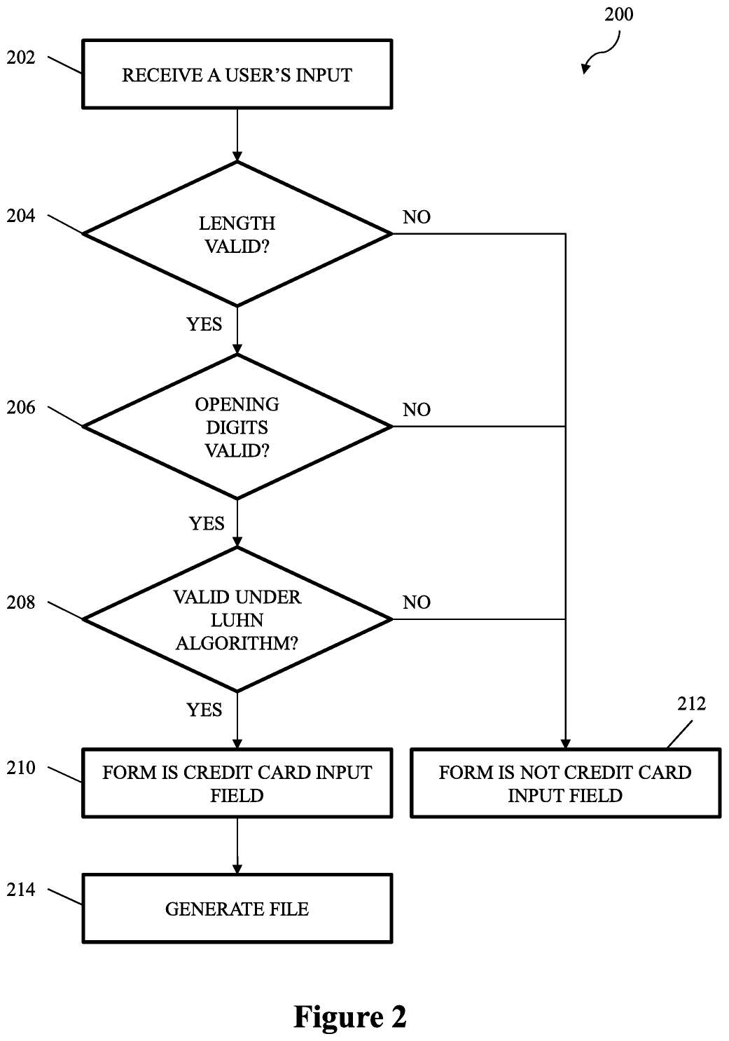

FIG.2 is a flowchart showing method 200 of identifying a credit card input field on a webpage, according to some embodiments of the present disclosure. When a webpage being visited by a user has not been recognized as a payment page, the system may be configured to determine if the user types in a credit card number on that page. At step 202, an input device may receive a user's input to one or more input fields. In some embodiments, the input device may include a keyboard, a mouse, or a touch screen.

At step 204, a processor may be configured to receive the user's input from the input device and determine if the user's input includes a numerical sequence. In some embodiments, the processor may be configured to continuously listen to the user's input. In some embodiments, the processor may be configured to receive the user's input when the user fills one input field and moves to another input field. In some embodiments, the processor may be configured to determine the number of digits in the numerical sequence and check if the number of digits matches a pre-determined value. In some embodiments, the pre-determined value may be set by a financial service provider. The financial service provider, in some embodiments, may be a third-party financial service provider. In some embodiments, the financial service provider may be a payment card issuer. Credit cards issued by different issuers may have different lengths of digits. For example, credit cards affiliated with the MasterCard® usually have a number of 16 digits, whereas credit cards issued by American Express™ usually have 15 digits. If the number of digits does not match a pre-determined value, method 200 may proceed to step 212 in which the processor may determine that the user's input does not include a credit card number and thus the input field is not a credit card input field. Otherwise, if the processor determines that the number of digits is valid, method 200 may proceed to step 206.

At step 206, the processor may be configured to validate one or more opening digits of the numerical sequence. In some embodiments, the processor may be configured to determine if the one or more opening digits match a pre-defined sequence which may identify a financial service type/network. In some embodiments, the financial type may include a credit card processor, a debit card processor, or a gift card processor. In some embodiments, the financial service network may include one of American Express®, UnionPay®, Diners Club®, Discover®, JCB®, MasterCard®, or Visa®. For example, some common opening digits may include: 4(Visa®), 51-55 (MasterCard®), 34 and 37 (American Express™). In some embodiments, the financial service type/network may include other service types or networks. In some embodiments, the first six digits of a card number may be used as an issuer identification number (IIN). Therefore, by checking if the opening digits match a known IIN, the processor may determine if the numerical sequence is a valid credit card number. If the opening digits do not match any pre-defined sequence, the method 200 may proceed to step 212 in which the processor may determine that the user's input does not include a credit card number and thus the input field is not a credit card input field. Otherwise, if the opening digits are valid, the method can proceed to step 208.

At step 208, the processor may be configured to further validate the numerical sequence using a pre-determined validation algorithm. In some embodiments, the widely-used Luhn algorithm may be used to determine if the numerical sequence is a valid credit card number. Luhn algorithm (disclosed in U.S. Pat. No. 2,950,048) is a checksum formula to validate a numerical sequence against errors, which has been incorporated into the international standard ISO/IEC 7812-1 for bank card numbering system. In some embodiments, other validation algorithms may also be used for the validation process. If the numerical sequence does not pass the validation, method 200 may proceed to step 212 in which the processor may determine that the user's input does not include a credit card number and thus the input field may not be a credit card input field. If the numerical sequence is verified, method 200 may proceed to step 210 in which the processor may determine that the user's input includes a credit card number and thus the input field may be a credit card input field.

At step 214, the processor may be configured to generate a rule file associated with the webpage. The rule file may label the input field on the webpage as a credit card input field. In some embodiments, the rule file may include a hostname, and a detection rule. The hostname may be used for recognizing the webpage. The detection rule may include descriptions of the credit card input field.

In some embodiments, the processor may be configured to store the rule file in a local storage device. In some embodiments, the processor may be configured to transmit the rule file to a server. In some embodiments, the server may be configured to store the rule file in a storage device associated with the server. When another browser extension retrieves this rule file from the server, it may be able to automatically recognize this particular webpage as a payment page and locate the credit card input field.

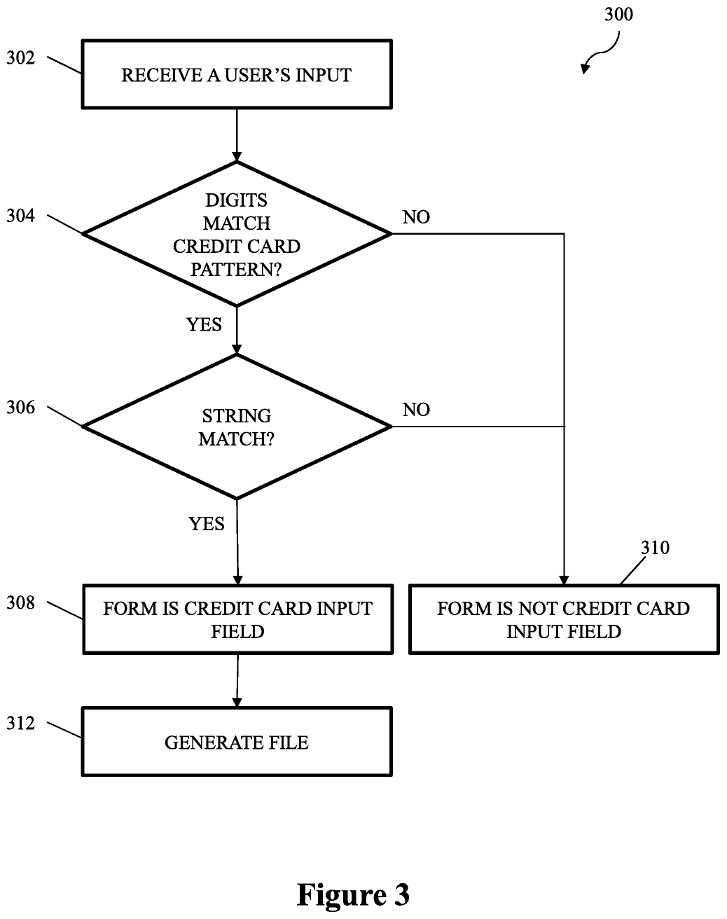

FIG. 3 is a flowchart showing another method 300 of identifying a credit card input field on a webpage, according to some embodiments of the present disclosure. When a webpage being visited by a user has not been recognized as a payment page, the system may be configured to determine if the user types in a credit card number on that page. At step 302, an input device may receive a user's input to one or more input fields. In some embodiments, the input device may include a keyboard, a mouse, or a touch screen.

At step 304, the processor may be configured to determine if the user's input includes a numerical sequence and if the numerical sequence is a valid credit card number. In some embodiments, the processor may implement one or more steps disclosed in method 200 as shown in FIG. 2. For example, the processor may be configured to determine the number of digits in the numerical sequence and check if the number of digits matches a pre-determined value. This pre-determined value may be set by a financial service provider. In some embodiments, the processor may be configured to validate one or more opening digits of the numerical sequence. For example, the processor can determine if the one or more opening digits match a pre-defined sequence identifying a financial service type/network. In some embodiments, the processor may be configured to further validate the numerical sequence using a pre-determined validation algorithm. If the user's input does not include a numerical sequence or the numerical sequence in the user's input does not match a valid credit card number pattern, method 300 may proceed to step 310 in which the processor may determine that the user's input does not include a credit card number and thus the input field is not a credit card input field. If the numerical sequence is determined to match a credit card pattern, method 300 may proceed to step 306.

At step 306, the processor may be configured to determine if the webpage contains any characters that may match pre-determined text. For example, the processor may be configured to scan the webpage and identify any labeling text around the input field. The processor may then be configured to determine if the labeling text matches pre-determined text. In some embodiments, the pre-determined text may include, but is not limited to: “credit card number”, “expiration”, “EXP”, “CVV”, “security code”, or “verification code”. If the labeling text does not match the pre-determined text, method 300 may proceed to step 310 in which the processor may determine that the input field is not a credit card input field. If the labeling text matches the pre-determined text, method 300 may proceed to step 308 in which the processor may determine the input field is a credit card input field.

At step 312, the processor may be configured to generate a rule file tagging the input field on the webpage as a credit card input field. In some embodiments, the rule file may include a hostname and a detection rule. The hostname may be used for recognizing the webpage. The detection rule may include descriptions of the credit card input field.

In some embodiments, the processor may be configured to store the rule file in a local storage device. In some embodiments, the processor may be configured to transmit the rule file to a server and the server may be configured to store the rule file in a storage device associated with the server. When another browser extension retrieves this rule file from the server, it may be able to automatically recognize this particular webpage as a payment page and locate the credit card input field.

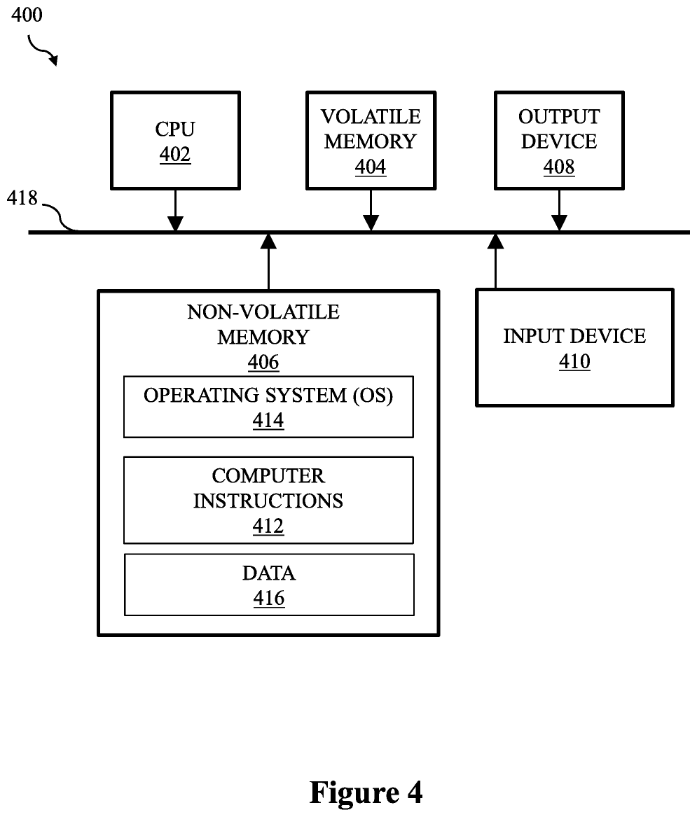

FIG. 4 shows illustrative computer 400 that can perform at least part of the processing described herein, according to an embodiment of the disclosure. Computer 400 may include processor 402, volatile memory 404, non-volatile memory 406 (e.g., hard disk), output device 408 (e.g., a display), and input device 410 (e.g., a mouse, a keyboard), each of which is coupled together by bus 418. The non-volatile memory 406 may be configured to store computer instructions 412, operating system 414, and data 416. In one example, computer instructions 412 are executed by processor 402 out of volatile memory 404. In some embodiments, computer 400 corresponds to a virtual machine. In other embodiments, computer 400 corresponds to a physical computer.

Referring again to FIG. 4, processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Additionally, the software included as part of the concepts, structures, and techniques sought to be protected herein may be embodied in a computer program product that includes a computer-readable storage medium. For example, such a computer-readable storage medium can include a computer-readable memory device, such as a hard drive device, a CD-ROM, a DVD-ROM, or a computer diskette, having computer-readable program code segments stored thereon. In contrast, a computer-readable transmission medium can include a communications link, either optical, wired, or wireless, having program code segments carried thereon as digital or analog signals. A non-transitory machine-readable medium may include but is not limited to a hard drive, compact disc, flash memory, non-volatile memory, volatile memory, magnetic diskette and so forth but does not include a transitory signal per se.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component, or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A computer-implemented method of securing credit card number transmission by a webpage with a browser extension, comprising:
receiving, by an input device, a user's input for a field on the webpage, wherein the user's input comprises a numerical sequence having a total number of digits wherein one or more of the digits are opening digits;
receiving, by a processor, the user's input from the input device;
determining, by the browser extension, that the web page is not one that is known to be a payment page;
determining, by the browser extension, that the number of digits matches a pre-determined value;
determining, by the browser extension, that the one or more opening digits match a pre-defined sequence;
determining, by the browser extension, by the matching of the predetermined value and the predefined sequence, that the user's input from the input device is a credit card number;
generating, by the browser extension, a file associated with the webpage, wherein the file labels the input field as a credit card number input field, in response to the number of digits matching the pre-determined value and the one or more opening digits matching the pre-defined sequence; and
transmitting, by the processor, the generated file to a server, wherein the server is configured to store the file in a storage device associated with the server.

2. The method of claim 1, wherein the pre-determined value is set by a financial service provider.

3. (canceled)

4. (canceled)

5. The method of claim 2, wherein the financial service provider is of a type selected from the group consisting of a credit card processor, a debit card processor, and a gift card processor.

6. The method of claim 1, further comprising:
determining that the numerical sequence is valid under the Luhn algorithm; and
updating the file labeling the input field as containing a correct credit card number.

7. The method of claim 1, further comprising:
scanning one or more characters on the webpage;
determining that the one or more characters on the webpage match one or more pre-determined texts; and
updating the file labeling the input field as containing a credit card number.

8. The method of claim 7, wherein the one or more pre-determined texts comprise one of “credit card number”, “CVV”, “security code”, “verification code”, “expiration date”, and “EXP”.

9. A computer-implemented method of securing credit card number transmission by a webpage, comprising:
receiving, by a server, a user's input for a field on the webpage from a user device, wherein the user's input comprises a numerical sequence having a total number of digits wherein one or more of the digits are opening digits;
receiving, by a processor, the user's input from the user device;
determining, by the processor, that the webpage is not one that is known to be a payment page;
determining, by the processor, that the number of the digits matches a pre-determined value;
determining, by the processor, that the one or more opening digits match a pre-defined sequence;
determining, by the processor by the matching of the predetermined value and the predefined sequence, that the user's input from the user device is a credit card number;
determining, by the processor, that the numerical sequence is valid under the Luhn algorithm;
generating, by the processor, a file associated with the webpage, wherein the file labels the input field as a credit card number input field containing a correct credit card number; and
storing the generated file in a memory.

10. The method of claim 9, wherein the user device comprises a computer or a mobile device.

11. The method of claim 9, wherein the pre-determined value is defined by a financial service provider.

12. The method of claim 9, wherein the pre-defined sequence identifies a financial service provider.

13. (canceled)

14. A system for securing credit card number transmission by a webpage, comprising:
an input device configured to receive a user's input, wherein the user's input comprises a numerical sequence having a plurality of digits wherein one or more of the digits are opening digits;
a memory configured to store program instructions; and
a processor configured to execute the program instructions causing the processor to:
receive the user's input from the input device;
determine that the web page is not one that is known to be a payment page;
determine that the number of digits matches a pre-determined value;
determine that the one or more opening digits match a pre-defined sequence;
determine that the numerical sequence is valid correct under a pre-determined algorithm;
generate a file associated with the webpage, wherein the file labels the input field as a credit card number input field containing a correct credit card number, in response to the number of the digits matching the pre-determined value, the one or more opening digits matching the pre-defined sequence and the numerical sequence being correct under the pre-determined algorithm; and
transmit the generated file to a server, wherein the server is configured to store the file in a storage device associated with the server.

15. The system of claim 14, wherein the pre-determined value is defined by a financial service provider.

16. (canceled)

17. The system of claim 14, wherein the financial service provider is of a type selected from the group consisting of a credit card processor, a debit card processor, and a gift card processor.

18. The system of claim 14, wherein the pre-determined algorithm comprises the Luhn algorithm.

19. The system of claim 14, wherein the program instructions further cause the processor to:
scan one or more characters on the webpage; and
determine that the one or more characters match one or more pre-determined texts,
wherein the input field is labeled as a credit card number input field containing a correct credit card number, in response to the number of the digits matching the pre-determined value, the one or more opening digits matching the pre-defined sequence, the numerical sequence being correct under the pre-determined algorithm, and the one or more characters matching the one or more pre-determined texts.

20. The system of claim 19, wherein the one or more pre-determined texts comprise one of “credit card number”, “CVV”, “security code”, “verification code”, “expiration”, and “EXP”.

21. The method of claim 1, further comprising substituting, by the browser extension, the user's input with another identifiable number.

22. The method of claim 1, further comprising communicating with a server to authenticate the user, to fetch virtual card information, to retrieve updated detection or population rules, or to send metrics to the server.

23. The method of claim 9, further comprising substituting, by the processor, the user's input with another identifiable number.

24. The system of claim 14, wherein the program instructions further cause the processor to substitute the user's input with another identifiable number.
